(19) United States
(12) Patent Application Publication
(10) Pub. No.: US 2007/0002599 A1
(43) Pub. Date: Jan. 4, 2007

(54) Circuit board and arrangement for minimizing thermal and electromagnetic effects

(76) Inventor: Robin Caven, Helsinki (FI)

Correspondence Address: ARENT FOX PLLC, 1050 CONNECTICUT AVENUE, N.W., SUITE 400, WASHINGTON, DC, 20036, US

(21) Appl. No.: 10/546,924

(22) PCT Filed: Feb. 28, 2003
(86) PCT No.: PCT/FI03/00148

§ 371 Date: Sep. 5, 2006

(51) Int. Cl. H02M 1/00

(52) U.S. Cl. 363/144

(57) ABSTRACT

The present invention relates to a circuit board of DSLAM and an arrangement to minimize thermal flow or electro-magnetic radiation from digital side to analog side, or vice versa. The circuit board comprises analog components and passive digital components on first side of the circuit board and active digital components on the second side of the circuit board. The arrangement comprises an enclosure having the circuit board with analog components, passive digital components, and active digital components and a first component connected between the first portion and the second portion of the circuit board to restrict thermal flow or electromagnetic radiation from one portion to another portion.

### TECHNICAL FIELD OF THE INVENTION

The present invention relates to a circuit board of a DSLAM (Digital Subscriber Line Access Module) and to an arrangement for minimizing thermal flow or electromagnetic radiation from one side of the circuit board to another side of the circuit board.

### BACKGROUND OF THE INVENTION

The need to provide high data rate services (such as VDSL (Very high data rate Digital Subscriber Line) services) to more distant subscribers increases when the competition between the XDSL service providers becomes tougher. This need makes a challenge for XDSL equipment providers to design systems that decrease the costs of the overall system per customer.

One of the suggested solutions to provide high data rate services to increased number of subscribers is so called Fiber to the Cabinet, in which there is provided a fiber connection (having a transmission data rate of 1 Gbps) between the CO (Central Office) and a street cabinet (having a DSLAM in the street cabinet) and twisted-pair copper telephone line connections between the street cabinet and the subscribers. This solution provides a possibility to bring the high data rate connections to more distant subscribers. In this solution, the DSLAM is inserted to a street cabinet. Alternatively, the DSLAM may be inserted to a pole, manhole, or similar conditions. These conditions make certain requirements for the DSLAMs. For example, the circuitry of the DSLAM needs to be covered from water (e.g. rain), dust, and other elements that may affect the functioning of the DSLAM. In reality, the DSLAMs need to be made practically airtight.

A printed circuit board (PCB) used in DSLAMs (Digital Subscriber Line Access Modules) has various components. They have components such as analog components, digital components, and switching circuits.

The analog components are provided to enable the transmission of analog data from the DSLAMs to customer premises equipment (CPEs) through twisted-pair copper telephone lines (i.e. traditional telephone lines). The digital components are provided to the circuit boards to enable the transmission of digital data between the DSLAMs and the core network. The switching circuit(s) is provided for enabling forwarding data packets received from core network connection(s) to certain(s) twisted-pair copper telephone line(s), or vice versa. The data that is transmitted may be e.g. data provided in the Internet.

When the DSLAMs are made airtight (to prevent rain, etc. which affect the functioning of the DSLAM) the thermal effect between the components need to be eliminated (or at least minimized), i.e. some shielding between the components and cooling of the components need to be provided.

Furthermore, electromagnetic radiation between the different components of the circuit board of the DSLAM needs to be eliminated. One of the reasons for electromagnetic radiation from the digital components to the analog components is due to great signal speeds implemented by the digital components.

In one solution for eliminating the effects of different components to each other, the different parts or components (e.g. digital components and analog components) of the circuit board are encapsulated. In this solution there is a need to provide fans (or similar cooling devices) to eliminate the overheating of the components. The use of encapsulation and separate cooling devices increases the overall costs of the DSLAM.

### SUMMARY OF THE PRESENT INVENTION

It is an object of the present invention to overcome or at least mitigate the disadvantages of the prior art.

It is an object of the present invention to provide a solution in which the encapsulation of different components of circuit board may be eliminated or at least minimized.

Further, it is an object of the present invention to provide a solution in which separate cooling devices are not needed in the circuit board.

According to a first aspect of the present invention, there is provided a circuit board of a DSLAM (Digital Subscriber Line Access Module) having analog components, passive digital components, and active digital components, the circuit board comprising:
analog components on a first portion of a first side of the circuit board;
passive digital components on a second portion of the first side of the circuit board; and
active digital components on a second portion of a second side of the circuit board.

Preferably, a first component is fastened, with a fastener, to the circuit board between a first portion and the second portion of the second side of the circuit board, and/or a thermal element is placed between an enclosure and the active digital components, and/or a second component is fastened, with a fastener, to the circuit board from one end of the second portion of the second side of the circuit board.

Preferably, the first portion of the first side and a first portion of the second side of the circuit board form an analog portion of the circuit board, and the second portion of the first side and the second portion of the second side of the circuit board form a digital portion of the circuit board.

Preferably, the thermal element is placed between the first component and the second component.

Preferably, the circuit board is a circuit board of a remote DSLAM (Digital Subscriber Line Access Module) in a VDSL (Very high data rate Digital Subscriber Line) system.

Preferably, the first component is a metal nodule. Preferably, the second component is a metal nodule.

Preferably, the thermal element is a thermal pad.

Preferably, the fastener is a screw.

Preferably, the first nodule and/or the second nodule are connected to a ground plane of the circuit board with the fastener to conduct at least part of electromagnetic radiation to the ground plane.

Preferably, material of the metal nodule and/or thermal pad is aluminum, copper, or steel.

Preferably, there is provided an enclosure comprising a circuit board as described above. More preferably, the enclosure is a substantially airtight, metal enclosure.

Preferably, the first component, the second component, and the thermal element are integrated to the enclosure.

According to a second aspect of the present invention, there is provided an arrangement for minimizing thermal flow or electromagnetic radiation from a digital side of a circuit board to an analog side of the circuit board, or vice versa, the arrangement comprising:
an enclosure having a circuit board;
a circuit board having analog components on a first portion of a first side, a first portion of a second side, passive digital components on a second portion of the first side, and active digital components on a second portion of the second side; and
a first component connected between the first portion and the second portion of the circuit board to restrict thermal flow or electromagnetic radiation from one portion to another portion.

Preferably, the arrangement further comprises a thermal element placed between the first component and the second component connected to the circuit board to reduce thermal flow from one portion to another portion. More preferably, the first component is a metal nodule integrated into the enclosure.

Preferably, the enclosure is a DSLAM (Digital Subscriber Line Access Module).

The present invention provides various advantages over the prior art solutions. The circuit board and the arrangement according to the present invention enable to eliminate the need of encapsulation of various components in the DSLAM (or other devices having same kind of components). Also the need for cooling devices (such as fans) is minimized with the solution according to the present invention. The elimination (or minimization) of encapsulation and cooling devices also reduces the overall costs (i.e. being more cost effective solution).

Further advantages of the present invention over the prior art solutions are disclosed in the following with reference to certain embodiment of the present invention.

### BRIEF DESCRIPTION OF THE DRAWING

For a better understanding of the present invention and in order to show how the same may be carried into effect reference will now be made to the accompanying drawing, in which:

FIG. 1 shows a circuit board and an enclosure according to the preferred embodiment of the present invention.

### DETAILED DESCRIPTION OF CERTAIN EMBODIMENT

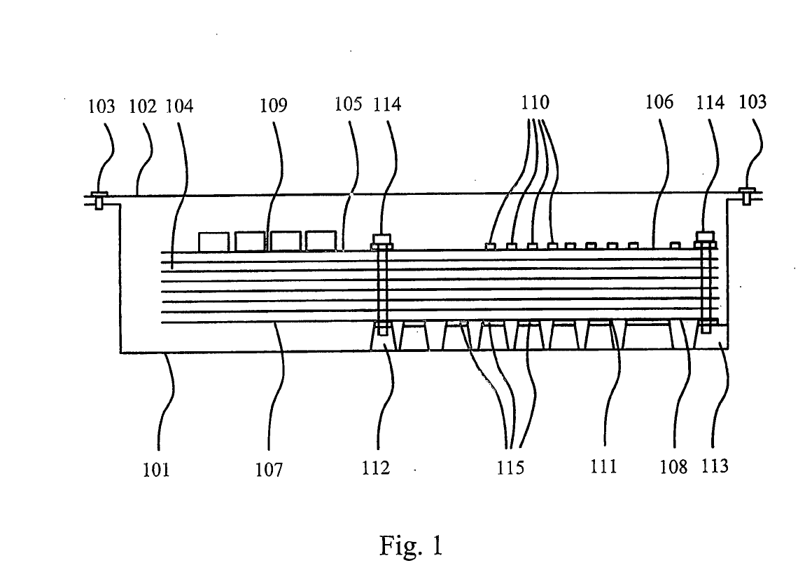

FIG. 1 shows a circuit board and an enclosure according to the preferred embodiment of the present invention. The enclosure (forming e.g. a remote DSLAM (Digital Subscriber Line Access Module) of a VDSL (Very hiah data rate Digital Subscriber Line) system) may be inserted to a street cabinet, a pole, a manhole, or similar conditions. The enclosure comprises two parts, i.e. a base 101 and a cover 102. The base 101 and the cover 102 are attached to each other with screws 103 (or similar fasteners). The enclosure usually also comprises some sealing means (not shown) for closing the enclosure tightly (preferably airtight). The tight enclosure prevents the moisture and other disadvantageous elements to affect the circuit board (also connectors, etc.) and its components. The enclosure is usually made of some metal (such as steel or alike).

The circuit board 104, which is a circuit board of a DSLAM in the preferred embodiment of the present invention, has multiple layers, which may be e.g. ground, power, and signal layers. The circuit board 104, which is preferably a printed circuit board, has a first portion 105 of the first side (i.e. upper side in FIG. 1), a second portion 106 of the first side, a first portion 107 of the second side (i.e. lower side in FIG. 1), and a second portion 108 of the second side.

The first portion 105 of the upper side and the first portion 107 of the lower side form an analog portion (or part) of the circuit board 104. On the first portion 105 of the upper side there is shown multiple analog components 109.

The second portion 106 of the upper side and the second portion 108 of the lower side of the circuit board 104 form a digital portion of the circuit board 104. Various passive (or bypass) components 110 are placed on the first portion 106 of the upper side of the circuit board 104. Because passive digital components 110 do not create remarkable thermal effect (flow) or electromagnetic radiation, which would affect to the functioning of the analog components 109, they are placed to the same side of the circuit board 104 as the analog components 109.

The active digital components 111 shown on the second portion 108 of the lower side of the circuit board 104 in FIG. 1, however, create heat and electromagnetic radiation that would affect to the functioning of the analog components 109 of the circuit board 104. Therefore, the active digital components 111 are placed on the opposite side of the circuit board 104. This placement of the active digital components 111 to the opposite side of the circuit board 104 as the analog components 109 reduces the need for encapsulation and additional cooling devices for different components.

For minimizing thermal effect and/or electromagnetic radiation from digital side to analog side, or vice versa, there is further provided first 112 and second 113 nodules (i.e. components), which are integrated to the base 101 of the enclosure. The first nodule 112 is placed between the analog side and the digital side. The second nodule 113 is placed on the opposite end of the digital side of the circuit board 104. These nodules 112, 113 are connected to the circuit board 104 with screws 114 (or alike fasteners), which are capable of conducting at least part of the electromagnetic radiation to the ground layer(s) of the circuit board 104. Materials of these nodules 112, 113 are metals such as aluminum, copper or steel. Choosing the material for the nodules 112, 113 is based on the ability to conduct the electromagnetic radiation from the active digital components 111 to the ground layer(s) of the circuit board 104.

There is further shown thermal elements (thermal pads) 115 in FIG. 1. The thermal elements 115 are placed between the base 101 of the enclosure and the active digital components 111. The thermal elements 115 are preferentially integrated to the base 101 of the circuit board 104. Material of the thermal elements 115 is metal (such as aluminum, copper, steel, or alike) to enable the transfer of the heat of the active digital components 111 to the enclosure and therefrom outside of the enclosure.

The circuit board 104 of the DSLAM further has additional elements, such as a switch for forwarding data or a processor for upkeeping functions, which are not shown in FIG. 1. These elements are not described more detailed herein, since the preferred embodiment of the present invention considers an arrangement for minimization of thermal effect (flow) or electromagnetic radiation between the different components in the circuit board of the DSLAM and a circuit board of the DSLAM for enabling such actions. The additional elements of DSLAM are well known to the person skilled in the art.

It will be appreciated by the skilled person in the art that various modifications may be made to the above-described embodiments without departing from the scope of the present invention, as disclosed in the appended claims. For example, the material of the thermal element, the nodules, and/or the enclosure may be different (at least when the same functions are provided by those materials). Also additional elements/components may be added to the circuit board and/or to the enclosure.

1. A circuit board of a DSLAM (Digital Subscriber Line Access Module) having analog components, passive digital components, and active digital components, the circuit board comprising:
analog components on a first portion of a first portion side of the circuit board;
passive digital components on a second portion of the first side of the circuit board; and
active digital components on a second portion of a second side of the circuit board.

2. A circuit board according to claim 1, wherein a first component is fastened, with a fastener, to the circuit board between a first portion and the second portion of the second side of the circuit board.

3. A circuit board according to claim 1, wherein a thermal element is placed between an enclosure and the active digital components.

4. A circuit board according to claim 1, wherein the first portion of the first side and a first portion of the second side of the circuit board form an analog portion of the circuit board.

5. A circuit board according to claim 1, wherein the second portion of the first side and the second portion of the second side of the circuit board form a digital portion of the circuit board.

6. A circuit board according to claim 1, wherein a second component is fastened, with a fastener, to the circuit board from one end of the second portion of the second side of the circuit board.

7. A circuit board according to claim 6, wherein the thermal element is placed between the first component and the second component.

8. A circuit board according to claim 1, wherein the circuit board is a circuit board of a remote DSLAM (Digital Subscriber Line Access Module) in a VDSL (Very high data rate Digital Subscriber Line) system.

9. A circuit board according to claim 2, wherein the first component is a metal nodule.

10. A circuit board according to claim 3, wherein the thermal element is a thermal pad.

11. A circuit board according to claim 6, wherein the second component is a metal nodule.

12. A circuit board according to claim 2, wherein the fastener is a screw.

13. A circuit board according to claim 2, wherein the first nodule and/or the second nodule are connected to a ground plane of the circuit board with the fastener to conduct at least part of electromagnetic radiation to the ground plane.

14. A circuit board according to claim 8, wherein material of the metal nodule and/or thermal pad is aluminum, copper, or steel.

15. An enclosure comprising a circuit board according to claim 1.

16. An enclosure according to claim 15, wherein the first component, the second component, and the thermal element are integrated to the enclosure.

17. An enclosure according to claim 15, wherein the enclosure is a substantially airtight, metal enclosure.

18. An arrangement for minimizing thermal flow or electromagnetic radiation from a digital side of a circuit board to an analog side of the circuit board, or vice versa, the arrangement comprising:
an enclosure having a circuit board;
a circuit board having analog components on a first portion of a first side, a first portion of a second side, passive digital components on a second portion of the first side, and active digital components on a second portion of the second side; and
a first component connected between the first portion and the second portion of the circuit board to restrict thermal flow or electromagnetic radiation from one portion to another portion.

19. An arrangement according to claim 18, wherein the arrangement further comprises a thermal element placed between the first component and the second component connected to the circuit board to reduce thermal flow from one portion to another portion.

20. An arrangement according to claim 18, wherein the first component is a metal nodule integrated into the enclosure.

21. An arrangement according to claim 18, wherein the enclosure is a DSLAM (Digital Subscriber Line Access Module).
